(19) United States
(12) Patent Application Publication
(10) Pub. No.: US 2001/0050294 A1
(43) Pub. Date: Dec. 13, 2001

(54) Adhesive dispensing and vision system for an automatic assembly system

(76) Inventors: Edward Michael Plattner, Riverside, CA (US); Paul Ebeling, Tucson, AZ (US)

Correspondence Address: QUARLES & BRADY LLP, RENAISSANCE ONE, TWO NORTH CENTRAL AVENUE, PHOENIX, AZ, 85004-2391, US

(21) Appl. No.: 09/866,440

(22) Filed: May 25, 2001

Related U.S. Application Data
(60) Provisional application No. 60/207,469, filed on May 25, 2000.

(51) Int. Cl. B05B 7/00

(52) U.S. Cl. 222/630

(57) ABSTRACT

Apparatus and method for the formation and application of small drops of liquid to a workpiece at a predetermined location thereon. The apparatus includes a machine vision system including a computer operable to view the drop as it is being formed and calculate a value indicative of the drop volume and control formation of the drop using the value. Application of the drop to the workpiece is also monitored and controlled by the machine vision system. The method and apparatus are particularly suited for use in the application of very small drops having actual volumes of less than about 30 nanoliters.

### TECHNICAL FIELD OF THE INVENTION

This invention relates to the field of automated assembly systems and more specifically to an adhesive dispensing and vision system for an automatic assembly system.

### BACKGROUND OF THE INVENTION

In the manufacture of devices such as electronic circuit boards, electronic components and other miniature or subminiature devices it is often necessary to deposit liquid (including semi-liquids), like glue, in small amounts, for example less than 30 nanoliters (nl), at very precise locations on a workpiece. In applying liquid to such components several problems have been encountered. Controlling the volume of the drop as it is being formed has been difficult because of the extremely small quantity of liquid in the drop. These quantities can be 30 nl and smaller and often are less than 5 nl. A 20 nl drop, if spherical, would have a diameter of approximately 0.016 centimeters or 0.006 inches. In addition to dealing with very small volumes, in many applications, it is extremely important for dispensing systems to deposit drops that have very tight tolerances on volume onto a workpiece. Another important factor in the application of such small drops is that in many instances the placement of a drop must be accurately controlled. The inability to accurately control drop volume and location leads to increased scrap and the time consuming re-work of workpieces.

Numerous dispensing devices are available for depositing small quantities of liquid. However, those devices fail to adequately control one or more of the above factors. In addition to the foregoing, current apparatus for applying small drops cannot verify that the drop was applied on the correct location or verify that the correct amount of liquid was applied. Incorrect location of the liquid or correct location of the liquid with inadequate volume can lead to the processing of a bad workpiece. The accomplishment of proper drop application is also complicated in the case of applying liquid by building up the liquid on a dispensing nozzle. This approach, for the current apparatus could adversely affect the application of a drop to a workpiece.

There is thus a need for an improved apparatus and method for applying small drops of liquid to a workpiece.

### SUMMARY OF THE INVENTION

Among the several objects and features of the present invention may be noted the provision of an apparatus and method that can be utilized to apply small drops of liquid, such as glue, to workpieces for such things as subsequent attachment of components thereto. The apparatus utilizes a machine vision system including a video camera connected to a computer to view a drop of liquid being formed at a dispensing nozzle and to determine an approximate value for the volume of the drop. The computer provides a signal to a liquid pump to control its operation and hence the volume of the drop as it is being formed. The vision system can also be utilized to control the volume of liquid applied to the workpiece. After application of a drop, the apparatus is capable of verifying the location of the applied drop prior to further processing of the workpiece. If a drop of liquid on the nozzle is too large or there is a build-up on the applicator of excess liquid, for example when glue is the liquid, mechanism is provided to remove the excess or build-up of the liquid. A workpiece manipulator is also provided for moving a workpiece to a position adjacent a drop on the dispensing nozzle (applicator) and is operable to precisely place the workpiece relative to the drop in at least X, Y, and Z axes and when properly positioned move the workpiece into the drop a predetermined amount (Z axis movement) to apply at least a portion of the drop to the workpiece. After application of one or more drops, the workpiece is moved such that it can be viewed by a second video camera to determine the location(s) of the applied drop(s) to confirm that they have been properly applied. The apparatus is particularly applicable for the application of small drops of liquid for example, 30 nl or less.

Other objects and features will be in part apparent and in part pointed out hereinafter.

### BRIEF DESCRIPTION OF THE DRAWINGS

For a more complete understanding of the device and advantages thereof, reference is now made to the following descriptions in which like reference numerals represent like parts:

FIG. 1a is a front elevation view of an apparatus used for robotically moving and assembling parts;

FIG. 1b is an elevation view of the apparatus of FIG. 1;

FIG. 1c is a cutaway overhead view of the apparatus;

FIG. 2 is plan view of an apparatus for applying drops of liquid to a workpiece.

FIG. 3 is a side view of the apparatus of FIG. 2 as viewed from the direction indicated by arrow A of FIG. 2.

FIG. 4 is a side view of the apparatus of FIG. 2 as viewed from the direction indicated by the arrow B of FIG. 2.

FIG. 5 is an enlarged view of an applicator nozzle and camera.

FIGS. 6a-6d are enlarged views of an applicator nozzle with a drop of liquid formed.

FIGS. 7a-7c illustrate the application of a drop to a work piece.

FIG. 8 is a view of a work piece from an upward viewing camera.

FIG. 9 is a flow chart of the operation of the apparatus.

### DETAILED DESCRIPTION OF THE INVENTION

The term “liquid” as used herein includes those substances that are technically liquid but also includes substances that would be more accurately classed as pressure flowable semi-liquids such as plastics, solids or semi-solids for example, grease, paste, gums and the like which are not technically liquids but can be forced through a nozzle for application to a workpiece, for adhesion thereto. The liquid can be oils, glues, adhesives, lubricants, solvents, cleaners, dyes, paints, etc. The liquid may also contain solid materials therein as well as dissolved and entrained gases.

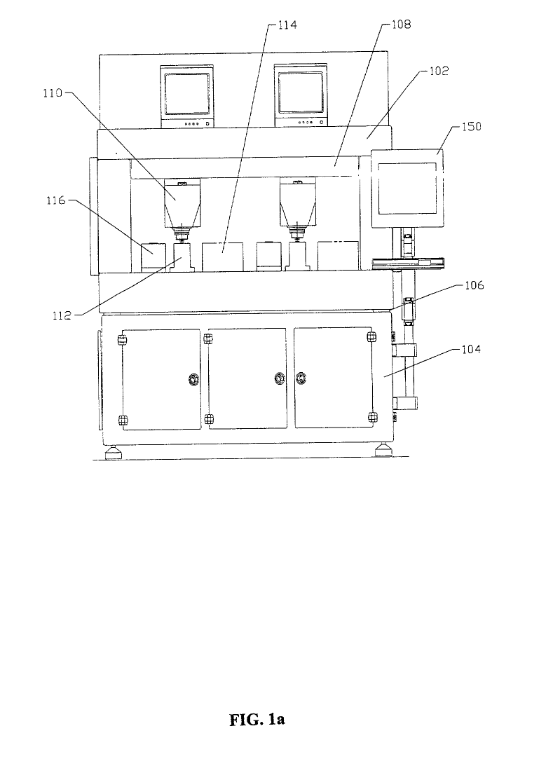

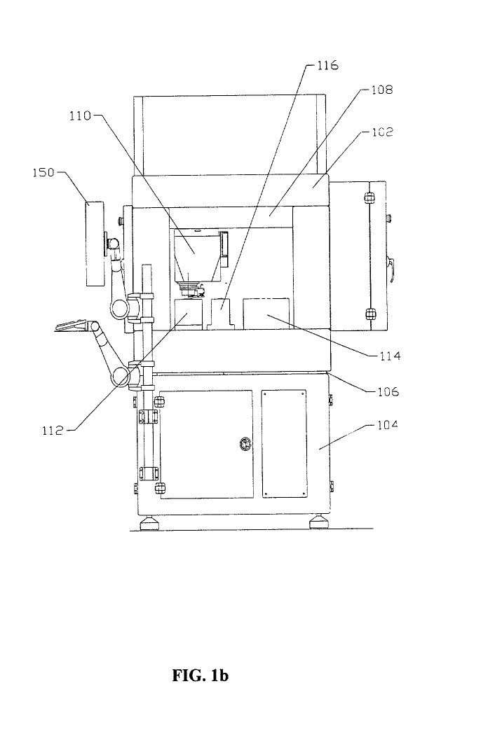

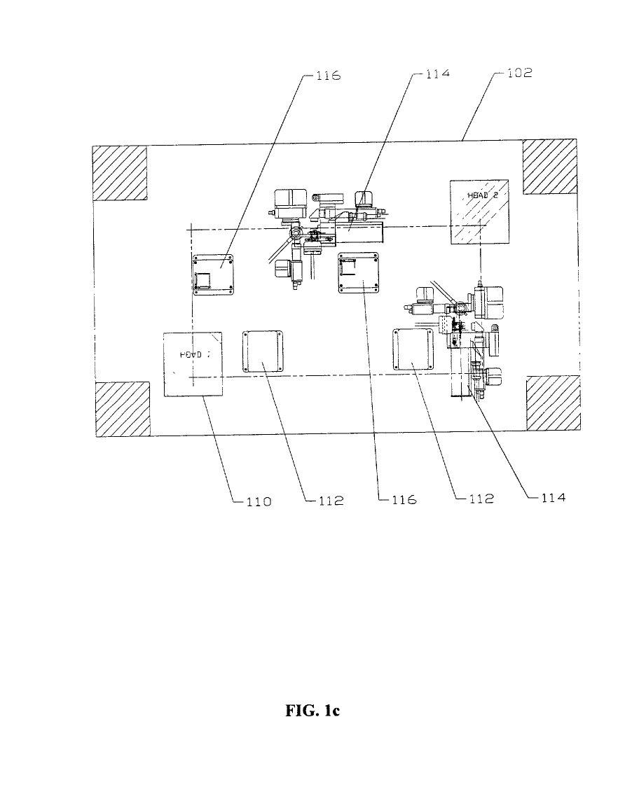

FIG. 1a is a front view of an assembly system 100, FIG. 1b is a side view of assembly system 100 and FIG. 1c is a cutaway overhead view of the assembly system 100. Illustrated in these drawings are an assembly system 100. Assembly system 100 includes a top portion 102 coupled to a base portion 104 using isolation pad 106. Top portion 102 is preferably manufactured from granite. Top portion includes a top surface 102a and a bottom surface 102b. Base portion 104 is preferably manufactured using a welded structural steel. Isolation pad 106 is manufactured from urethane. Top portion 102, base portion 104 and isolation pad 106 together form an assembly system that is extremely rigid and vibration free.

Inside top portion 102 and coupled to a top surface 102a is a robot platen 108. Coupled to robot platen 108 is a manipulator device 110. Robot platen 108 in one embodiment is a magnetic plate. Manipulator device 110, discussed in further detail below, is able to move about the magnetic plate. This is accomplished by injecting compressed air between the manipulator device 110 and the robot platen 108. This forms what is commonly known as an air bearing between the manipulator device 110 and robot platen 108.

Inside top portion 102 and coupled to a base plate 102b are an adhesive dispense system 114, part assembly station 112, and a part pick up station 116. Adhesive dispense system 114 is described in further detail below.

Part assembly station 112 is an area where an object may be assembled with another. Part pickup system 116 is an area where manipulator device 110 can pick up a part have it operated on at a station such as the adhesive system and then move the part at the assembly station.

Bottom portion 104 provides a rigid support base for top portion 102. Bottom portion 102 also provides an area to place an AC distribution enclosure as well as mount controls and provide various storage areas.

A computer 150 including is provided to control the manipulator device 110, part processing station 114 and other parts of the system 100. Computer 150 can be any general purpose computer, such as a small office computer running the WINDOWS operating system, as sold by Microsoft, Corp. of Redmond , Wash. Computer 150 will typically include a display screen, keyboard, sensor inputs and other input output connections.

In operation, under computer control or, optionally under manual control, manipulator device 110 utilizing the air bearing formed between manipulator device 110 and robot platen 108, will move over to part pickup station 116 where it will acquire a work piece. Manipulator device 110 will then move the work piece to the part assembly station 112 such as an adhesive dispensing system 114. There, the adhesive dispensing system 114 applies adhesive to the work piece. The manipulator device 110 will then move the work piece to part assembly station 112 where the manipulator device 110 will place the work piece on a second work piece while applying force to connect the two work pieces.

The manipulator 110 is operable to move a workpiece in at least X, Y, and Z directions for positioning over the nozzle 202 for the application of liquid to the workpiece at predetermined locations thereon. The manipulator 110 is also operable to position the workpiece over an upward viewing camera to confirm the locations of the drops applied to the workpiece.

The details of construction and operation of the manipulator 110 are disclosed in co-pending U.S. patent application Ser. No. ______, entitled “MANIPULATOR/END EFFECTOR HEAD FOR ROBOTIC ASSEMBLY”, and filed May 25, 2001. The disclosure of that application is incorporated herein by reference.

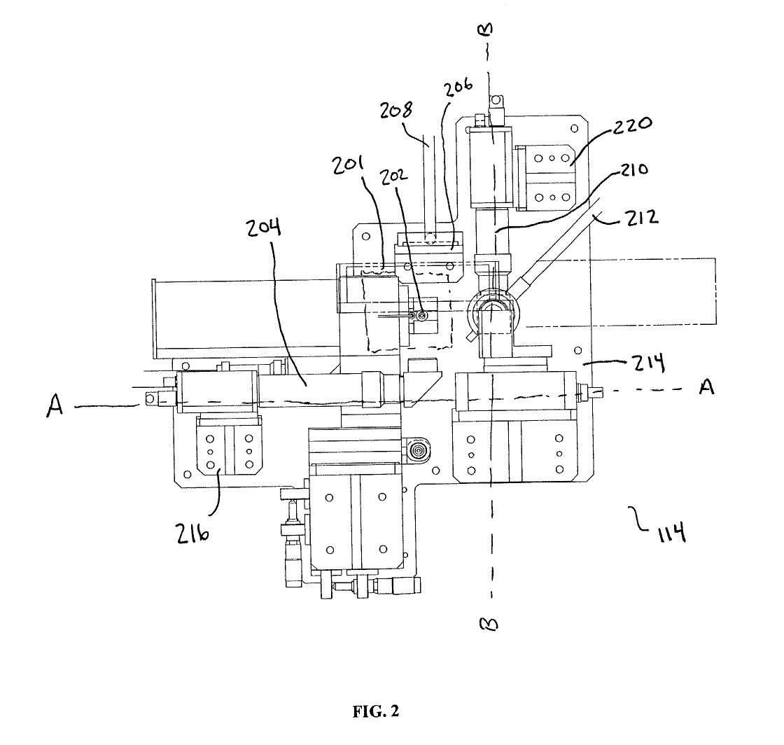

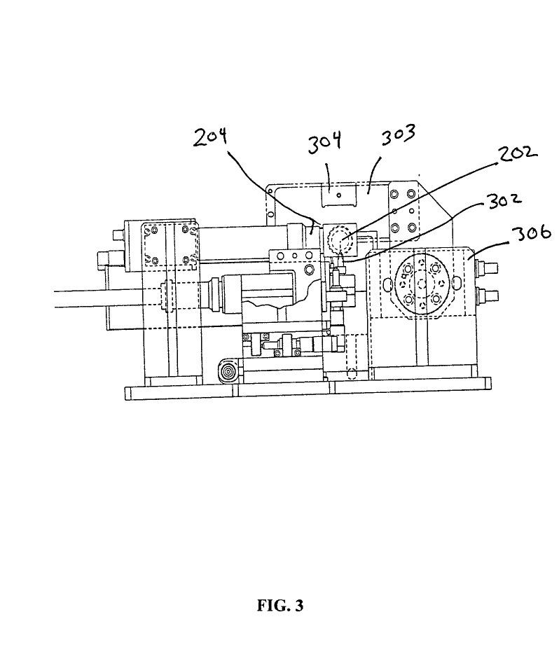

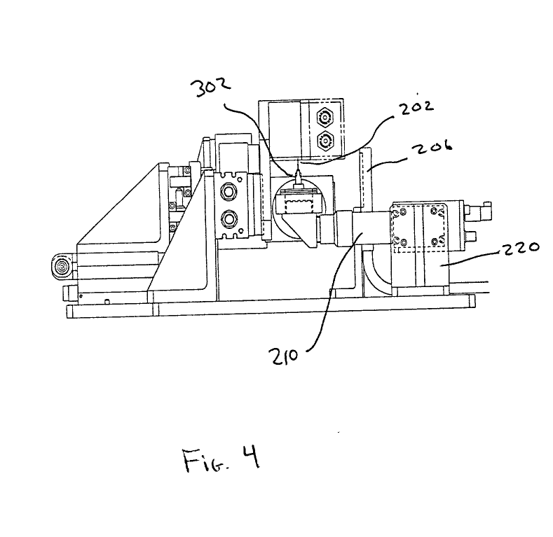

FIGS. 2, 3 and 4 are views of an adhesive dispensing station 114 in accordance with the teaching of the present inventions. Illustrated is a dispenser 201 including a nozzle 202 for the application of one or more drops of liquid. A first vision system designated generally 204 is positioned to view drops that are formed from time to time on the end of the nozzle 202. The vision system 204 is operable to provide information to a computer to add in calculating the volume of a drop prior to its application to a workpiece. Vision system 204 is also operable to provide a signal indicative of the location of a workpiece relative to the drop to control the application of the drop to the workpiece. A second vision system 212 may be provided to view the surface of a workpiece where one or more drops have been applied and provide signals indicative of the locations of the applied drops. A blotting device may be to remove drops from the nozzle if the drops are too large and/or to remove unwanted build-up of liquid, for example, glue, from the nozzle.

The blotter mechanism 303 is also mounted on the base 214 and is operable for selectively, and on command, to remove a drop or build up of liquid from the nozzle 202. The blotter 303 includes a cassette 304 that is moveably mounted on the base 214 via an X-Y movement mechanism 306. The mechanism 306 is operable to move the cassette 304 into selective engagement with the nozzle 202 to remove a drop therefrom or a build up of liquid on the nozzle 202. If the drop 602 is large, as calculated by computer 150, the blotter will blot the drop 602. Also, if too much time elapse after the formation of a drop, the drop is blotted off. In one embodiment, blotting is done on a regular basis to ensure fresh drops.

The dispenser 201, nozzle 202 and blotter 303 are mounted on a base 214. A computer 150, such as a PC, is seen schematically in FIG. 1, the computer 150 is connected to various components of the apparatus 114 for controlling operations of the apparatus 114.

The operation of the various components of the apparatus 114 are controlled by the computer 150 which is connected to the cameras 205 and 207 to form the vision systems. The computer 150 is also connected to controller elements of the X-Y blotter movement mechanism 306 and the manipulator 110 to provide signals thereto to control their operations. Likewise, the computer 150 is connected to the dispenser 201 to provide signals thereto for controlling its operation. The computer 150 is also operable to receive information from the cameras 208 and 209, process that information and generate control signals for controlling operation of the dispenser 201, manipulator 110, and blotter 303.

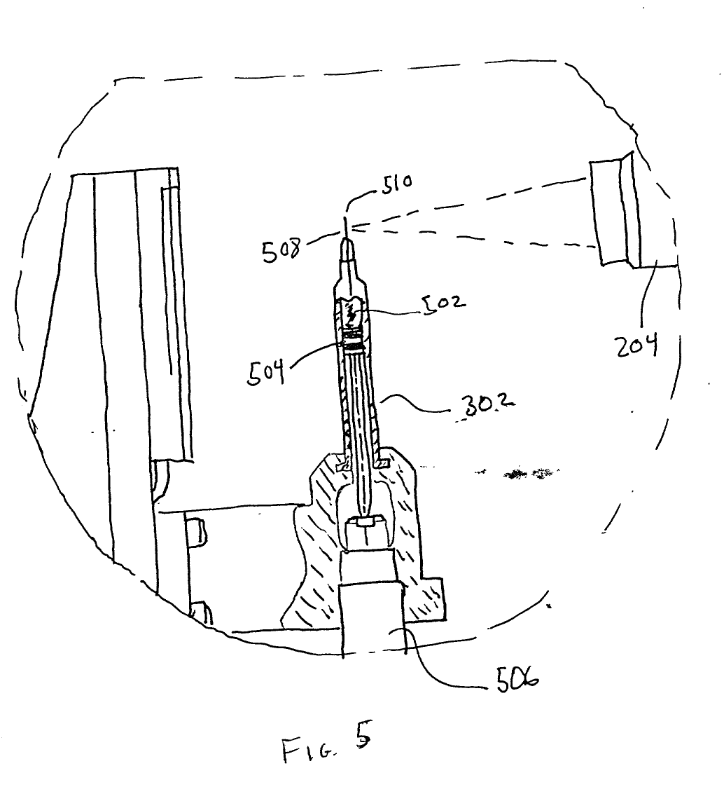

The dispenser 201 includes a means for supplying the liquid such as a positive displacement pump 402, or any other pumping means such as a rotary pump and the like. Turning to FIG. 5, in the embodiment illustrated, the pump is a syringe like device having a body 302 forming a reservoir 502 with a piston 504 therein which is selectively driven forward and backward in the body 302 by a servo motor 506 connected to the piston 504. Alternatively, a separate source of liquid may be connected in flow communication with the dispenser 201 and the nozzle 202 and would be operable to supply liquid thereto. As shown in FIG. 5, the nozzle 202 is upwardly opening having a free end 508 that is at the top of the nozzle 202. A discharge orifice 510 opens onto the free end 508 for the formation of a drop thereon. The nozzle 202 can be in the form of a small diameter needle with a flow passage therein communicating between the reservoir 502 and the exit orifice 510. When dispensing small quantities of liquid, the nozzle 202 can have an outside diameter in the range of about 0.008 inches through 0.030 inches and the orifice 510 can have a diameter in the range of about 0.004 inches through about 0.020 inches. When formed, the drop will be on and project upwardly from the free end 508 of the nozzle. Such dispensers 201 are commercially available of which the DISPENSE 2000 available from IVER Corp. of North Springfield, Vt. is an example. In one embodiment of the present invention, the nozzle 202 is stationary while the workpiece is moved by an overhead robotic manipulator 110 to and into the drop as described below. In an alternate embodiment the workpiece is stationary and the nozzle 202 is moved to the workpiece or, both the workpiece and nozzle 202 could be moved. Further, the nozzle 202 could be oriented in a downward direction whereby the drop would form on the bottom end and be applied to an upwardly facing surface of the workpiece. Other orientations of the nozzle 202 could also be utilized.

The first and second vision systems 204 and 210 can be the same general type vision systems but mounted at different orientations and locations for viewing the nozzle and/or the workpiece. The first vision system 204 includes a video camera and lens assembly and the first vision system 204 is adjustably mounted on the base 214 by an adjustable bracket 216. The bracket 216 permits adjustment of first vision system 204 in two axes i.e. horizontally and vertically. The adjustable bracket 216 can also permit rotation of the lens portion of the first vision system 204 for proper viewing of the free end 508 of the nozzle 202 along with the drop thereon and a portion of the workpiece as seen in FIGS. 5-7. The first vision system 205 is designed to be spaced far enough from the nozzle 202 to allow access to the nozzle 202 by a workpiece for the application of liquid thereto while permitting adequate viewing of the drop and workpiece.

In the illustrated embodiment of FIGS. 2-4 the first vision system 204 is allowed to provide generally horizontally viewing of the side of the nozzle 202 as well as the drop. A back light 206 is mounted on the base 114 and, as the lens assembly 207 views the back light 206 in its position on the back side of the nozzle 202, the back light 206 illuminates and silhouettes the drop and nozzle. The back light 206 can be any suitable light source as for example, a IT 9420 by Illuminations Technology of Syracuse N.Y., type light.

The second vision system 210 also includes a video camera with a lens assembly. The second vision system 210 is positionally adjustably mounted on the base 114 by a bracket 220. The bracket 220 permits adjustment of the position of the lens system 211 in X, Y, and Z axes. A suitable light 212 is provided to illuminate the object to be viewed by the second vision system 210. As seen in FIG. 2, the light produces a ring light 222 that surrounds objective lens end of the lens assembly 211 of second vision 210. In a preferred embodiment, the lens assembly of second vision system 210 directs it field of view generally upwardly to view the bottom surface of a workpiece attached to a manipulator device 110.

The cameras for the first vision system 204 and the second vision system 210 can be any suitable video camera such as an XC-75 available from Sony Corp. The focus distance, field of view, depth of field and focal length of the cameras for the first vision system 204 and the second vision system 210 are such as to permit their positioning relative to the nozzle and workpiece so as to not interfere with the operation of the apparatus.

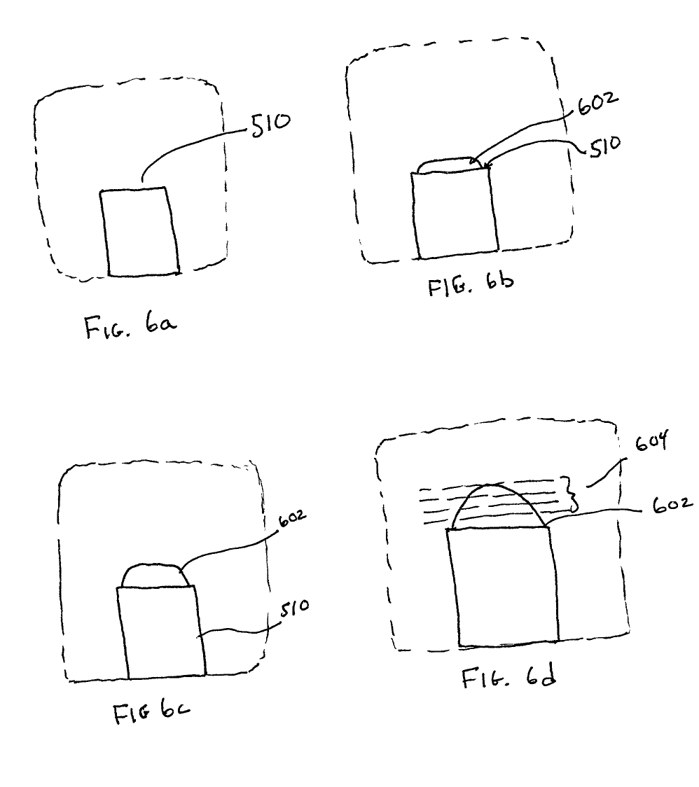

FIGS. 6a-6d illustrate a view of nozzle 202 as it dispenses adhesive in order to determine the volume dispensed. FIG. 6a is a view of nozzle 202 with opening exit orifice 510. FIG. 6b and FIG. 6c shows the build up of a drop 602 on nozzle 202. FIG. 6c shows the final size drop 602 before application to a work place. These figures shows first vision system 204 image. The information gathered by first vision system 204 is sent to computer 150 where the volume of the drop is calculated. As camera 205 takes an image of the drop, computer 150 is operable to view slices of the drop and calculate the volume of the slices as individual cylinders and then sum the cylinders together to get the overall volume. FIG. 6d illustrates a drop 602 with lines 604 showing the divisions where the cylinder calculations are made.

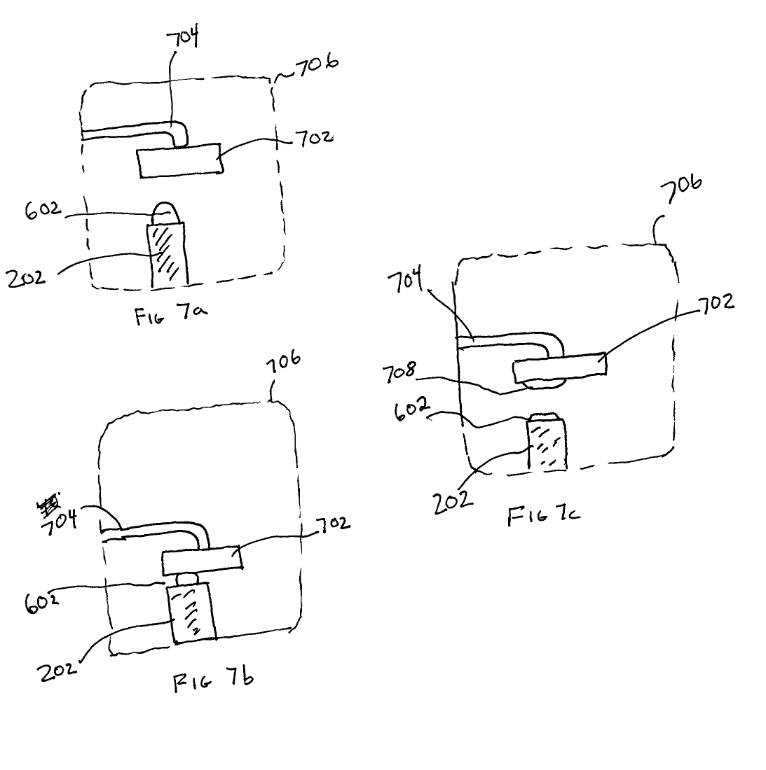

FIG. 7 illustrates the application of an adhesive to a workpiece 702. FIG. 7a illustrates a workpiece 702 attached via a vacuum to a gripper 704 which is attached to manipulator 110. Also illustrated is needle 202 with a drop 602 formed thereupon. Both the workpiece 702 and needle 202 with drop 602 are shown within the field of view 706 first vision system 204 of the camera 205. At this point, the volume of drop 602 on nozzle 202 can be calculated.

FIG. 7b shows the work piece moved down (z-axis direction) to the glue drop to get the glue on to workpiece 702. Then, in FIG. 7c, the work piece is moved up from the nozzle 202. Now, a second glue drop 708 is attached to work piece 702. Computer 150 is operable to calculate the volume of the glue drop 602 remaining on nozzle 202. By taking the difference between the original drop in FIG. 7a and the reduced drop in FIG. 7c, the amount applied to work piece 702 can be determined to ensure proper coverage. While FIGS. 7a-7c show the application of one dot of glue 708, any number can be applied by moving the workpiece and applying more glue.

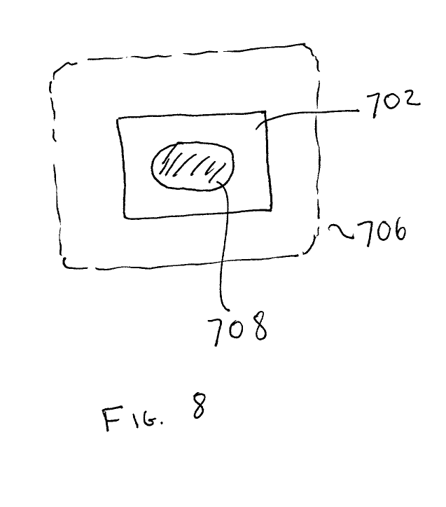

FIG. 8 illustrates a view of workpiece 702 as seen from second camera 213. Illustrated is workpiece 702 with glue drop 708 applied. This view allows for a qualitative indication of glue placement.

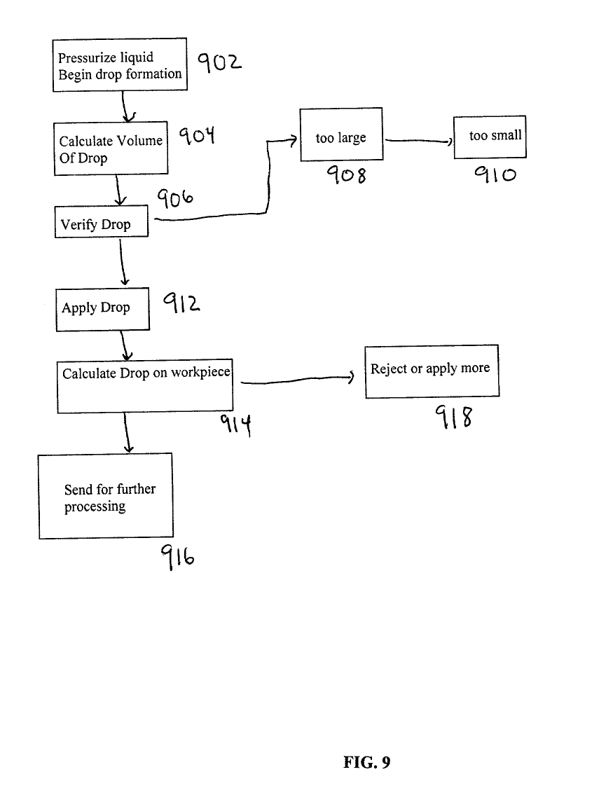

A flow chart of the operation of the adhesive assembly system 150 is seen in FIG. 9. In step 902, a pump is pressurizing liquid for dispensing from the nozzle 202 and a camera 205 views the formation of the drop 602. In step 904, information regarding the drop 602 is transmitted to the computer 150 which processes the information to provide a signal indicative of the volume of the drop as it is being formed and the final volume of the drop.

As discussed in conjunction with FIG. 6,the volume calculation is preferably accomplished by viewing the drop in slices, measuring the width of each slice within the drop and using the measured dimensions to calculate an approximate volume of each slice of the drop and thereafter adding (integrating) the calculated volumes to provide an estimate of the volume of the drop. It is assumed for the calculations that the drop 602 is spherical. If the liquid to be dispensed has a generally constant viscosity, the volume could be estimated by knowing the height or height and width of the drop thereby simplifying the calculation of an estimated volume. The computer provides a signal to the servo motor attached to the pump to control operation of the pump and thus the size of the drop formed on nozzle 202. The size of the drop is monitored throughout its formation and when the desired volume is reached, operation of the pump is terminated and the drop is subsequently applied to a workpiece 23. The size of the drop is re-evaluated after its formation is stopped in step 906. Should the drop 602 be too large, in step 908, the computer sends a signal to the blotting mechanism to remove the oversized drop after which a subsequent drop is formed for application to the workpiece 23. Should the drop be too small, in step 910,the pump can be reactivated to enlarge the drop or the drop may be removed by the blotter and a new one formed for subsequent application.

When the drop 602 reaches a target volume or a volume within a target range of volumes, in step 912, the computer 150 terminates operation of the pump and sends a signal to the manipulator 110 to lower the workpiece into the drop 602. The vision system 205 also views the movement of the workpiece into the drop 602. When the workpiece has moved into the drop a predetermined amount, downward movement of the workpiece is terminated by control of the manipulator 110.

The computer 150 is also connected to the manipulator 110 to provide control signals thereto for controlling operation of the manipulator which moves a workpiece in at least X, Y, and Z axes directions as preprogrammed for a particular workpiece. Rotational movement in a θ direction may also be provided. The manipulator 110 first moves a workpiece into the appropriate X-Y location over the nozzle 212. When in the appropriate X-Y location, the manipulator 110 will lower (Z direction movement) the workpiece into the drop 602 a predetermined distance. When the workpiece is in the appropriate X-Y location and prior to Z direction movement, the vision system 205 views the space between the top of the drop and the bottom surface of the workpiece onto which the drop is to be applied. Data is gathered by the computer 150 from the vision system 205 regarding the spacing. The computer then calculates the amount of Z direction movement that is required for the appropriate movement (to achieve application of the correct amount of liquid) of the workpiece into the drop 602. A signal is then provided to the manipulator 110 by the computer 150 to effect the appropriate Z direction movement.

After application of a drop to the workpiece the vision system 205 continues to view the remaining portion of the drop on the nozzle 202. In step 914, the volume of the remainder of the drop is calculated as described above. The remaining volume is subtracted from the beginning volume to confirm that the target value for volume of applied drop size was achieved. If the target value of drop size was achieved then, in step 916, the workpiece will continue to be processed for example by the application of additional drops of liquid and the subsequent formation of an assembly using the workpiece. If the target value was not achieved then, in step 918, the part may be rejected, or if the drop size is not large enough additional liquid may be applied. If the workpiece can be reworked and is reworked, it can then continue on for additional processing for completion.

After application of the drop 602, the workpiece is then raised in the Z direction and advanced to the next location on the workpiece needing a drop of liquid or if the workpiece is completed with the application of the drop, then the workpiece can be moved to a position over the second vision system 213 for verification of the locations and/or sizes of the applied drops. The camera 213 provides data to the computer 150 for analysis to determine if the drops have been applied in the appropriate X-Y locations. If not, the part may be rejected or returned to the nozzle for correction by the application of drop(s) in the appropriate location(s).

In view of the above, it will be seen that the several objects of the invention are achieved and other advantageous results attained.

When introducing elements of the present invention, or the preferred embodiment(s) thereof, the articles “a,” “an,” and “the” are intended to mean there are one or more of the elements. The terms “comprising,” “including,” and “having” are intended to be inclusive and mean that there may be additional elements other than the specific listed elements.

As various changes could be made in the above construction without departing from the scope of the invention, it is intended that all matter contained in the above description or shown in the accompanying drawings shall be interpreted as illustrative and not in a limiting sense.

What is claimed is:

1. An apparatus for dispensing small quantities of liquid comprising:
a liquid dispenser with a discharge nozzle having a discharge orifice adjacent to a free end of the nozzle;
a first camera directed at the free end of the nozzle to capture an image of a drop of liquid on the free end in its field of view; and
a computer connected to the first camera and operable to process information from the first camera and generate a signal indicative of the volume of the drop of liquid on the free end.

2. The apparatus of claim 1, wherein the computer is coupled to the dispenser and is operable to control the size of the drop to be dispensed.

3. The apparatus of claim 2, wherein the computer is operable to calculate a value indicative of the volume of the drop prior to application to a workpiece and calculate a value indicative of the volume of the drop after application to the workpiece and to calculate a value indicative of the change in volume of the drop.

4. The apparatus of claim 3, wherein the computer is operable to calculate a value indicative of the volume based on the assumption that the drop is spherical.

5. The apparatus of claim 1, further comprising a blotter mechanism operable to remove a substantial portion of the drop on the nozzle if the drop exceeds a predetermined size.

6. The apparatus of claim 1, wherein a manipulator is operable to move a workpiece to the nozzle to have a drop of liquid applied.

7. The apparatus of claim 6, further comprising a second camera positioned to view a drop of liquid once applied to the workpiece, the second camera being operably connected to a computer with the second camera and the computer to which the second camera is connected are operable to provide a signal indicative of the location of the drop on the workpiece and if the drop is not in the predetermined location, the apparatus is operable to return the workpiece to the nozzle for the application of another drop of liquid.

8. The apparatus of claim 1, wherein said orifice opens generally upwardly whereby a formed drop is on the free end of the nozzle.

9. The apparatus of claim 7, wherein the manipulator moves the workpiece down into a drop on the nozzle and the computer is operable to provide a second signal indicative of the spacing between a portion of the drop and the workpiece prior to the workpiece contacting the drop and is operable to control operation of the manipulator in accordance with the second signal.

10. The apparatus of claim 9, wherein the portion of the drop is a top of the drop.

11. An apparatus for depositing small quantities of liquid onto workpieces at predetermined locations comprising;
a liquid dispenser with a discharge nozzle having a discharge orifice;
a first camera directed at the discharge orifice to capture an image of a drop of liquid on the discharge orifice;
a second camera positioned to capture an image of at least a portion of a workpiece upon which a drop of liquid has been applied;
a computer coupled to the first and second cameras and operable to process information from the first and second cameras and generate signals indicative of the volume of the drop on the nozzle and of the position of the drop once applied to the workpiece.

12. The apparatus of claim 11 wherein a manipulator is operable to move the workpiece in X, Y, and Z axes and move the workpiece down into a drop.

13. The apparatus of claim 12, wherein the computer is operable to provide a second signal indicative of the spacing between a portion of the drop and the workpiece and limit the amount of movement of the workpiece into the drop.

14. The apparatus of claim 11, wherein the computer is coupled to the dispenser and is operable to control the size of the drop to be dispensed.

15. The apparatus of claim 11, wherein the computer is operable to calculate a value indicative of the volume of the drop prior to application to a workpiece and calculate a value indicative of the volume of the drop after application to the workpiece and to calculate a value indicative of the change in volume of the drop.

16. The apparatus of claim 11, further comprising a blotter mechanism operable to remove a substantial portion of the drop on the nozzle if the drop exceeds a predetermined size.

17. The apparatus of claim 11, wherein the orifice opens generally upwardly whereby a formed drop is on the free end of the nozzle.

18. The apparatus of claim 18, wherein the manipulator moves the workpiece down into a drop on the nozzle and the computer is operable to provide a second signal indicative of the spacing between a portion of the drop and the workpiece prior to the workpiece contacting the drop and is operable to control operation of the manipulator in accordance with the second signal.

19. A method of applying a small drop of liquid to a workpiece, comprising:
pressurizing a liquid with a pump;
inducing the liquid to flow out of an orifice of a nozzle to commence formation of a drop;
viewing said drop with a first machine vision system;
generating a signal indicative of the volume of the drop;
stopping the formation of the drop in response to the signal indicating a predetermined volume of the drop has been achieved; and
applying at least a portion of the thus formed drop to a workpiece.

20. The method of claim 19, further comprising removing the drop from the nozzle if the drop is larger than a predetermined maximum size and thereafter forming another drop for application to a workpiece.

21. The method of claim 19, wherein the step of pressurizing a liquid with a pump further comprises controlling formation of the drop by controlling operation of the pump in response to the signal.

22. The method of claim 19, wherein the step of generating a signal further comprises calculating the value indicative of the volume of the drop by assuming the drop is spherical and by measuring multiple dimensions of the drop.

23. The method of claim 19, wherein the drop is formed on the top of a nozzle with the orifice opening onto a free end of the nozzle.

24. The method of claim 19, wherein the step of applying further comprises:
moving the workpiece to the nozzle such that a predetermined location on the workpiece is over the thus formed drop; and
lowering the workpiece into the drop a predetermined distance and thereby apply at least a portion of said drop to said workpiece.
